(19) United States
(12) Patent Application Publication
(10) Pub. No.: US 2009/0152071 A1
(43) Pub. Date: Jun. 18, 2009

(54) DECELERATION DEVICE FOR VEHICLE, ELECTRONIC PARKING BRAKE AND ELECTRONIC MOTOR BRAKE USING REDUCTION DEVICE

(75) Inventor: Gabbae JEON, Gunpo-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/246,307

(22) Filed: Oct. 6, 2008

(30) Foreign Application Priority Data
Dec. 15, 2007 (KR) 10-2007-0131801

(51) Int. Cl. B60W 10/18; F16H 63/34

(52) U.S. Cl. 192/222; 192/219.4

(57) ABSTRACT

The present invention provides a deceleration device for a vehicle comprising a planetary gear set having three parts of a sun gear, a carrier, and a ring gear; a driving motor connected and supplying a rotational force to one of the three parts of the planetary gear set; a speed control motor connected and supplying a changed rotational force to one of the other two parts than the part connected with the driving motor in the three parts of the planetary gear set; an output shaft connected to the other one part than the two parts connected with the driving motor and the speed control motor respectively in the three parts of the planetary gear set; and a motor controller controlling the driving motor and the speed control motor,

### CROSS-REFERENCE TO RELATED APPLICATIONS

The present application is based on, and claims priority from, Korean Application Serial Number 10-2007-0131801, filed on Dec. 15, 2007, the disclosure of which is hereby incorporated by reference herein in its entirety.

### FIELD OF THE INVENTION

The present invention relates to a deceleration device for a vehicle, particularly a deceleration device that has a compact configuration and can increase a torque to a desired level at a desired timing by adjusting a deceleration ratio to make various parts of the vehicle smoothly operate, an electronic parking brake using and an electronic motor brake using the deceleration device.

### BACKGROUND OF THE INVENTION

FIG. 1 shows the structure of an electronic parking brake used in vehicles in the related art, in which a rotational force of a motor 500 is sequentially transmitted to a first gear 502, a second gear 504, and a third gear 506, and third gear 506 is integrally provided to a bidirectional adjustment screw 508. As bidirectional adjustment screw 508 rotates, third gear 506 pulls or releases an actuating nut 512 having an end thread-fastened to bidirectional adjustment screw 508 and the other end connected to a parking brake cable 510 to lock or unlock a parking brake.

According to a structure for increasing a torque by reducing the rotational speed of motor 500, and transmitting the torque to third gear 506, first gear 502, second gear 504, and third gear 506 are sequentially engaged, that is, a gear with the small number of teeth and a gear with the large number of teeth are repeatedly engaged, such that the rotational speed is reduced and the torque is increased by the gear ratio, which is a basic connection structure having sequentially engaged external gears.

Therefore, the deceleration ratio of a deceleration device composed of first, second, and third gears 502, 504, 506 is a predetermined constant.

In the electronic parking brake as described above, characteristics of a load of motor 500, a deceleration ratio, and a cable tension with respect to a stroke of parking brake cable 510 are as in a graph shown in FIG. 2.

It is needed to increase the size of the gears or the number of engaged gears to increase a torque outputted from a deceleration device, such as the type of the deceleration device composed of first, second, and third gears 502, 504, 506, but this configuration increases the size and volume of the deceleration device, causes problems, such as interference with other parts around, and results in limit of the deceleration ratio.

Further, when the deceleration device as described above is used, the relationship of deceleration ratio with the time to required stroke of parking brake cable 510 may be as FIG. 3. That is, when the deceleration ratio is set large to obtain a large torque, the stroke of parking brake cable 510 is decreased, such that the time to arrive the required stroke increases. Therefore, the deceleration ratio of the deceleration device is limited within a predetermined range.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provide a deceleration device for a vehicle that has a compact configuration with relatively small volume and can adjust a deceleration ratio and an output torque to desired levels, depending on the operational conditions of involved devices, in order to output desired deceleration ratio and output torque at a desired timing such that the operational performance of the involved devices is improved, an electronic parking brake using the deceleration device, and an electronic motor brake using the deceleration device.

A deceleration device for a vehicle according to an exemplary embodiment of the invention includes a planetary gear set, a driving motor, a speed control motor, an output shaft, and a motor controller. The planetary gear set has three parts of a sun gear, a carrier, and a ring gear. The driving motor is connected and supplies a rotational force to one of the three parts of the planetary gear set. The speed control motor is connected and supplies a changed rotational force to one of the other two parts than the part connected with the driving motor in the three parts of the planetary gear set. The output shaft is connected to the other one part than the two parts connected with the driving motor and the speed control motor respectively in the three parts of the planetary gear set. The motor controller controls the driving motor and the speed control motor.

The driving motor may be connected to the sun gear of the planetary gear set, the speed control motor may be coupled to the ring gear of the planetary gear set, and the output shaft may be connected to the carrier of the planetary gear set.

Further, the present invention provides an electronic parking brake using a deceleration device for a vehicle, in which the output shaft of the above deceleration device for a vehicle is connected to an actuating part that pulls a parking brake cable of the electronic parking brake.

The actuating part connected with the output shaft in the electronic parking brake may be a bidirectional adjustment screw thread-fastened to actuating nuts connected with the parking brake cables at both sides.

The output shaft of the above deceleration device is connected to an actuating part that presses a guiding piston of the electronic motor brake to a brake disc.

The actuating part connected with the output shaft in the electronic motor brake may be a roller screw that presses the guiding piston by rotating a spindle such that a brake pad is pressed against the brake disc.

According to deceleration device for a vehicle of the invention, the configuration is compact with a small volume and it is possible to adjust the deceleration ratio and the output torque to desired levels at desired timings, depending on the operational conditions of the involved devices, such that it is possible to output desired deceleration ratio and output torque and improve the operational performance of the involved devices.

### BRIEF DESCRIPTION OF THE DRAWINGS

For better understanding of the nature and objects of the present invention, reference should be made to the following detailed description with the accompanying drawings, in which:

FIG. 1 is a view illustrating the structure of an electronic parking brake according to the related art;

FIG. 2 is a graph showing changes of a load of motor, a deceleration ratio, and a cable tension with respect to a stroke of a parking brake cable of an electronic parking brake according to the related art;

FIG. 3 is a graph showing the relationship of the deceleration ratio with the time to required stroke of the parking brake cable when a deceleration device according to the related art is used;

FIG. 4 is a view showing a deceleration device for a vehicle according to an exemplary embodiment of the invention;

FIG. 5 is a view an electronic parking brake using the deceleration device according to an exemplary embodiment of the invention;

FIG. 6 is a graph showing changes of a load of motor, a deceleration ratio, and a cable tension with respect to a stroke of a parking brake cable of the electronic parking brake shown in FIG. 5; and

FIG. 7 is a view showing an electronic motor brake using the deceleration device according to an exemplary embodiment of the invention.

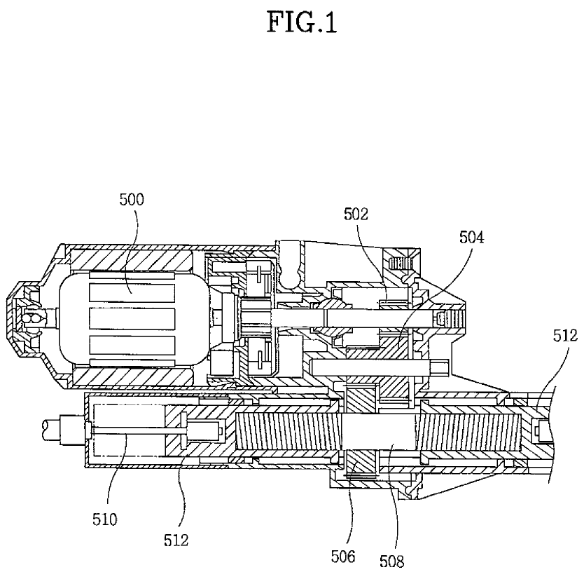

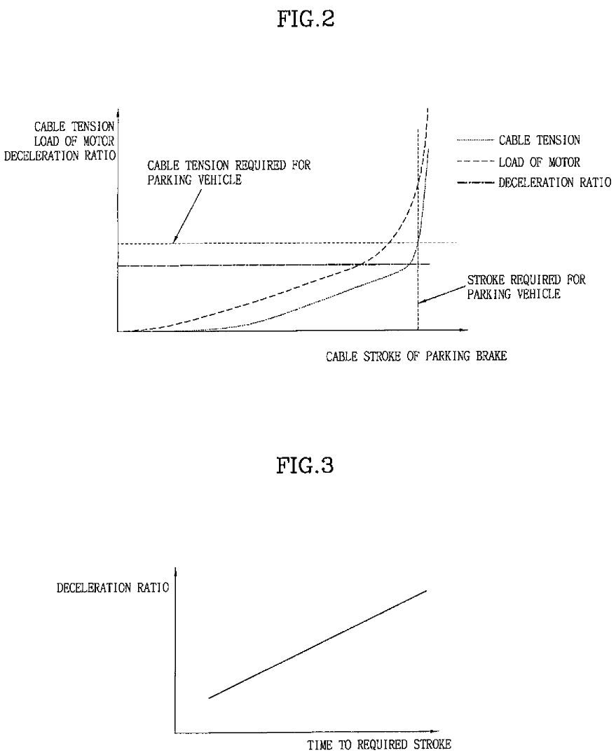

In the figures, reference numbers refer to the same or equivalent parts of the present invention throughout the several figures of the drawing.

### DETAILED DESCRIPTION OF THE PREFERRED EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

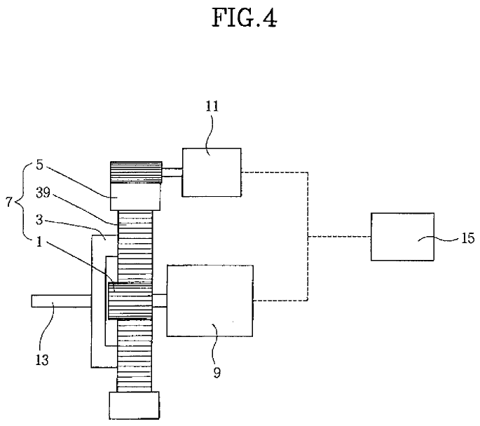

Referring to FIG. 4, a deceleration device for a vehicle according to an exemplary embodiment of the present invention includes: a planetary gear set 7 having three parts comprising a sun gear 1, a carrier 3, and a ring gear 5; a driving motor 9 connected and supplying a rotational force to one of the three parts of planetary gear set 7; a speed control motor 11 connected and supplying a changed rotational force to one of the other two parts than the part connected with driving motor 9 in the three parts of planetary gear set 7; an output shaft 13 connected to the other one part than the two parts connected with driving motor 9 and speed control motor 11 in the three parts of planetary gear set 7; and a motor controller 15 controlling driving motor 9 and speed control motor 11.

In this exemplary embodiment, driving motor 9 is connected to sun gear 1 of planetary gear set 7, speed control motor 11 is coupled to ring gear 5 of planetary gear set 7, and output shaft 13 is connected to carrier 3 of planetary gear set 7.

Alternatively, the connection of driving motor 9, speed control motor 11, and output shaft 13 with the parts of planetary gear set 7 may be changed from the above embodiment, depending on the detailed conditions.

The deceleration device having the above configuration uses, as a source for a rotational force to be outputted to output shaft 13, a rotational force generated by driving motor 9 and adjusts a deceleration ratio and an output torque by using a rotational force of speed control motor 11. That is, motor controller 15 drives driving motor 9, depending on a required torque of a device involved with the deceleration device according to an exemplary embodiment of the present invention and controls speed control motor 11 to adjust the deceleration ratio, such that the deceleration ratio and a torque by a rotational force outputted from output shaft 13 are changed in real time.

For example, when the gear ratio of sun gear 1, a planetary gear 39, and ring gear 5 of planetary gear set 7 is 1:1:3, as motor controller 15 controls speed control motor 11 such that a ratio of rotational angular speeds of sun gear 1 and ring gear 5 becomes 3:1, planetary gear 39 rotates on its axis without revolving and carrier 3 does not rotate correspondingly. Therefore, as motor controller 15 controls speed control motor 11 to adjust the ratio of the rotational angular speed of ring gear 5 with respect to sun gear 1, planetary gear set 7 can changes the rotational speed and the output torque that are outputted from carrier 3 to desired levels, depending on relative rotational angular speeds of sun gear 1 and ring gear 5.

The deceleration device as described above has an advantage of being capable of changing the deceleration ratio by controlling speed control motor 11, having a considerably compact configuration, as compared with deceleration devices having a simple gear train and outputting the same deceleration ratio in the related art.

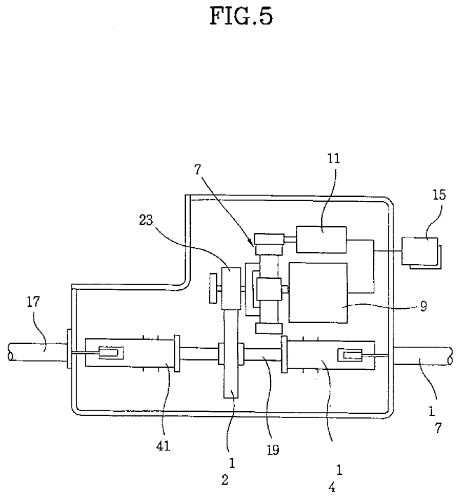

FIG. 5 illustrates an example applying the above deceleration device to an electronic parking brake, in which output shaft 13 of the deceleration device is connected to an actuating part that pulls a parking brake cable 17 of the electronic parking brake.

That is, the actuating part connected with output shaft 13 in the electronic parking brake is a bidirectional adjustment screw 19 thread-fastened to actuating nuts 41 connected with parking brake cables 17 at both sides.

Further, as shown in FIG. 5, bidirectional adjustment screw 19 is provided with a driven gear 21 and a driving gear 23 engaged with driven gear 21 is connected to output shaft 13 such that power can be transmitted.

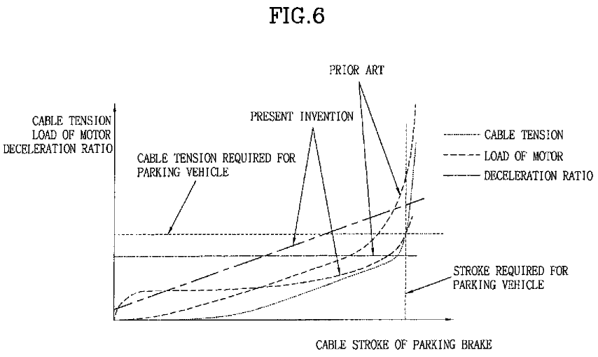

The electronic parking brake as described above shows characteristics of a load of motor, a deceleration ratio, and a cable tension with respect to parking brake cable 17 as show in FIG. 6, in which it can be seen that the load of motor and the deceleration ratio are different from the related art.

That is, as shown in FIG. 6, because it is possible to appropriately change the deceleration ratio at appropriate timings, depending on stroke conditions of a cable, smooth operation of the electronic parking brake can be secured by appropriately providing required torques at appropriate timing in the electronic parking brake.

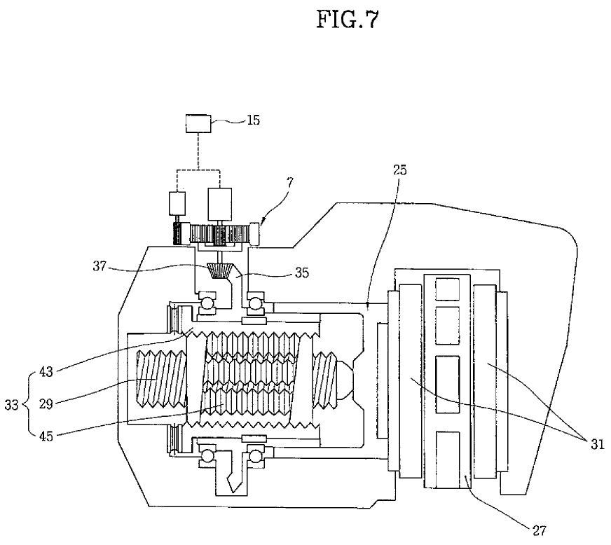

FIG. 7 shows the configuration of an electronic motor brake using a deceleration device for a vehicle according to another exemplary embodiment of the present invention, in which output shaft 13 of the deceleration device is connected to an actuating part that presses a guiding piston 25 of the electronic motor brake to a brake disc 27.

That is, the actuating part connected with output shaft 13 in the electronic motor brake is a roller screw 33 that presses guiding piston 25 using a spindle 29 such that a brake pad 31 is pressed against brake disc 27.

Further, a driven bevel gear 35 is connected to the outer circumference of roller screw 33 and a driving bevel gar 37 engaged with driven bevel gear 35 is provided to output shaft 13, such that a rotational force of output shaft 13 can be transmitted to roller screw 33 through driving bevel gear 37 and driven bevel gear 35.

In the above electronic motor brake, a rotational force generated from driving motor 9 is also provided to output shaft 13 through planetary gear set 7 by control of motor controller 15 while speed control motor 11 is controlled such that a desired torque is outputted from output shaft 13 at a desired timing, and accordingly the torque is transmitted to roller screw 33 of the electronic motor brake.

Roller screw 33 includes a nut 43, a roller 45, and spindle 29, in which spindle 29 pushes guiding piston 25, making a linear motion, by a rotational force transmitted to nut 43, while the force pushing guiding piston 25 is exerted as a force pressing brake pad 31 against brake disc 27, such that a braking force is obtained from the friction force between brake pad 31 and brake disc 27.

In the above operations, characteristics of a rapid linear motion at the earlier state and a large torque at the latter state of spindle 29 can be easily achieved by controlling speed control motor 11 using motor controller 15, such that it is possible to improve the operational performance of the electronic motor brake.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A deceleration device for a vehicle comprising:
a planetary gear set having three parts of a sun gear, a carrier, and a ring gear;
a driving motor connected and supplying a rotational force to one of the three parts of the planetary gear set;
a speed control motor connected and supplying a changed rotational force to one of the other two parts than the part connected with the driving motor in the three parts of the planetary gear set;
an output shaft connected to the other one part than the two parts connected with the driving motor and the speed control motor respectively in the three parts of the planetary gear set; and
a motor controller controlling the driving motor and the speed control motor.

2. The deceleration device for a vehicle as defined in claim 1, wherein the driving motor is connected to the sun gear of the planetary gear set,
the speed control motor is coupled to the ring gear of the planetary gear set, and
the output shaft is connected to the carrier of the planetary gear set.

3. An electronic parking brake using a deceleration device for a vehicle, wherein the output shaft of the deceleration device for a vehicle according to claim 1 is connected to an actuating part that pulls a parking brake cable of the electronic parking brake.

4. An electronic parking brake using a deceleration device for a vehicle, wherein the output shaft of the deceleration device for a vehicle according to claim 2 is connected to an actuating part that pulls a parking brake cable of the electronic parking brake.

5. The electronic parking brake using a deceleration device for a vehicle as defined in claim 4, wherein the actuating part connected with the output shaft in the electronic parking brake is a bidirectional adjustment screw thread-fastened to actuating nuts connected with the parking brake cables at both sides.

6. An electronic motor brake using a deceleration device for a vehicle, wherein the output shaft of the deceleration device according to claim 1 is connected to an actuating part that presses a guiding piston of the electronic motor brake to a brake disc.

7. An electronic motor brake using a deceleration device for a vehicle, wherein the output shaft of the deceleration device according to claim 2 is connected to an actuating part that presses a guiding piston of the electronic motor brake to a brake disc.

8. The electronic motor brake using a deceleration device for a vehicle according to claim 7, wherein the actuating part connected with the output shaft in the electronic motor brake is a roller screw that presses the guiding piston by rotating a spindle such that a brake pad is pressed against the brake disc.
